(19) United States
(12) Patent Application Publication
(10) Pub. No.: US 2017/0127229 A1
(43) Pub. Date: May 4, 2017

(54) METHOD AND APPARATUS FOR SEARCHING MOBILE NETWORK

(71) Applicant: Spreadtrum Hong Kong Limited, Kowloon (CN)

(72) Inventor: Samuli Heikkinen, Zhangjiang (CN)

(21) Appl. No.: 14/925,117

(22) Filed: Oct. 28, 2015

(51) Int. Cl. H04W 4/02; H04W 48/16; H04W 8/02

(52) U.S. Cl. CPC H04W 4/021; H04W 8/02; H04W 48/16

(57) ABSTRACT

The embodiments of the present disclosure provide a method for searching a mobile network, where the method may include: an apparatus, obtaining a set of geographic information indicating a location of the apparatus; obtaining a set of system information corresponding to the set of geographic information, wherein the set of system information comprises at least one system; obtaining at least one band for the at least one system; and searching the at least one band for the at least one system. Besides, the embodiments of the present disclosure further provide an apparatus for searching a mobile network. Accordingly, a scope of a mobile network search may be narrowed, thus searching all systems and all bands may be avoided.

### TECHNICAL FIELD

The present disclosure generally relates to telecommunications, and more particularly, to a method and an apparatus for searching a mobile network.

### BACKGROUND

Nowadays, mobile devices (e.g. cell phones, touch pads, etc.) typically support many systems (e.g. Global System for Mobile communications (GSM), Wideband Code Division Multiple Access (WCDMA), Time Division-Synchronous Code Division Multiple Access (TD-SCDMA), Long Term Evolution (LTE), etc.), and each of the systems generally includes many bands (e.g. bands 1 to 41), each of which is a set of continuous frequencies. Thus, searching all systems and all bands for selecting a Public Land Mobile Network (PLMN) with a highest priority is time consuming Conventionally, if a Registered PLMN (RPLMN) or Home PLMN (HPLMN) is available, the RPLMN or the HPLMN is allowed to be selected by the mobile devices for avoiding searching all systems and all bands. However, in some cases, neither the RPLMN nor the HPLMN is available. For example, the mobile devices enter a new country without any historical information available. Therefore, under this circumstance, all systems and all bands have to be searched.

### SUMMARY

Regarding to the problem addressed in the background, embodiments of the present disclosure provide a method for searching a mobile network, where the method may include: an apparatus, obtaining a set of geographic information indicating a location of the apparatus; obtaining a set of system information corresponding to the set of geographic information, wherein the set of system information may include at least one system; obtaining at least one band for the at least one system; and searching the at least one band for the at least one system.

In some embodiments, the set of system information corresponding to the set of geographic information that is obtained by accessing to a bank of information, which may at least include a corresponding relationship between the set of geographic information and the set of system information.

In some embodiments, prior to obtaining at least one band for the at least one system, whether the at least one system is supported by the apparatus that is determined.

In some embodiments, obtaining at least one band for the at least one system may include: obtaining all bands supported by the apparatus for each of the at least one system.

In some embodiments, obtaining at least one band for the at least one system may include: obtaining at least one band corresponding to the set of geographic information for the at least one system.

In some embodiments, obtaining at least one band for the at least one system may include: obtaining at least one band corresponding to the set of geographic information for each of the at least one system.

In some embodiments, prior to searching the at least one bands for the at least one system, whether the at least one band is supported by the apparatus that is determined.

Embodiments of the present disclosure provide an apparatus for searching a mobile network, where the apparatus may include at least one processor, which is configured for: obtaining a set of geographic information indicating a location of the apparatus; obtaining a set of system information corresponding to the set of geographic information, wherein the set of system information may include at least one system; obtaining at least one band for the at least one system; and searching the at least one band for the at least one system.

In some embodiments, the set of system information corresponding to the set of geographic information that is obtained by accessing to a bank of information, which may at least include a corresponding relationship between the set of geographic information and the set of system information.

In some embodiments, prior to obtaining at least one band for the at least one system, the at least one processor is configured for determining whether the at least one system is supported by the apparatus.

In some embodiments, the at least one processor is configured for obtaining at least one band for the at least one system may include: the at least one processor is configured for obtaining all bands supported by the apparatus for each of the at least one system.

In some embodiments, the at least one processor is configured for obtaining at least one band for the at least one system may include: the at least one processor is configured for obtaining at least one band corresponding to the set of geographic information for the at least one system.

In some embodiments, the at least one processor is configured for obtaining at least one band for the at least one system may include: the at least one processor is configured for obtaining at least one band corresponding to the set of geographic information for each of the at least one system.

In some embodiments, prior to searching the at least one bands for the at least one system, the at least one processor is configured for determining whether the at least one band is supported by the apparatus.

### BRIEF DESCRIPTION OF THE DRAWINGS

For better clarifying embodiments of the present disclosure, a brief description of drawings needed for describing the embodiments is provided. Obviously, the drawings which follow are the embodiments of the present disclosure. By taking effort with creativity, those skilled in the art can acquire other drawings based on the drawings provided.

FIG. 1 schematically illustrates a block diagram presenting a method for searching a mobile network according to one embodiment in the present disclosure;

FIG. 2 schematically illustrates a block diagram presenting an implementation of the method for searching a mobile network according to one embodiment in the present disclosure;

FIG. 3 schematically illustrates a block diagram presenting an implementation of the method for searching a mobile network according to another embodiment in the present disclosure;

FIG. 4 schematically illustrates a diagram presenting an example employing the implementation of the method for searching a mobile network according to one embodiment in the present disclosure; and

FIG. 5 schematically illustrates a diagram presenting another example employing the implementation of the method for searching a mobile network according to one embodiment in the present disclosure.

### DETAILED DESCRIPTION

With respect to the problem addressed in the background, the inventor discovers that, with at least obtaining a set of geographic information, a scope of a mobile network search may be narrowed that only a part of bands or a part of systems corresponding to the set of geographic information may be searched, thus searching all systems and all bands may be avoided, even under a circumstance that an apparatus is located at a new place, where the apparatus does not have any historical information regarding to the new place but geographic information of the new place may be obtained from a Global Positioning System (GPS), a user input or a System Information (SI) message.

In order to clarify the objects, characteristics and advantages of the present disclosure, embodiments of the present disclosure will be described in detail in conjunction with the accompanying drawings. However, in certain instances, well known or conventional details are not described in order to avoid obscuring the description of the inventive concepts set forth in the embodiments described herein. References to “one embodiment,” “an embodiment,” “another embodiment,” “yet another embodiment,” or their respective variations in the present disclosure are not necessarily references to the same embodiment; and, such references mean at least one.

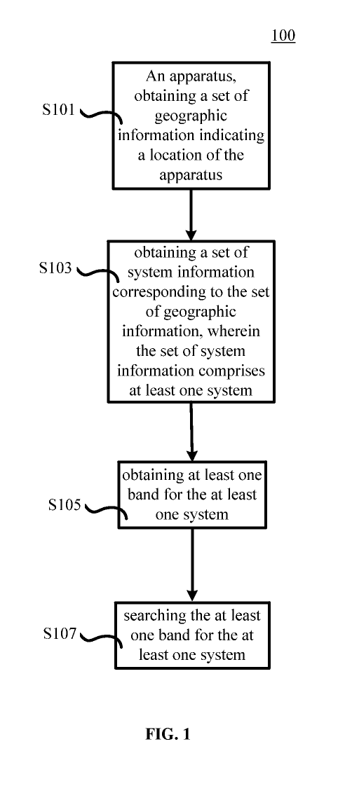

The embodiments of the present disclosure provide a method for searching a mobile network. FIG. 1 schematically illustrates a block diagram presenting a method 100 for searching a mobile network according to one embodiment in the present disclosure.

Referring to FIG. 1, the method 100 may include:
S101: an apparatus, obtaining a set of geographic information indicating a location of the apparatus;
S103: the apparatus, obtaining a set of system information corresponding to the set of geographic information, wherein the set of system information may include at least one system;
S105: the apparatus, obtaining at least one band for the at least one system; and
S107: the apparatus, searching the at least one band for the at least one system.

Specifically, in S101, the apparatus obtains a set of geographic information indicating a location of the apparatus. Wherein, the set of geographic information may include but be not limited to: a country code such as a Mobile Country Code (MCC), or a GPS coordinate.

Specifically, in S103, the apparatus obtains a set of system information corresponding to the set of geographic information, wherein the set of system information may include at least one system. Wherein, the at least one system is selected from a group including but being not limited to: GSM, WCDMA, TD-SCDMA and LTE.

In some embodiments, in S103, the apparatus obtains a set of system information corresponding to the set of geographic information, wherein the set of system information may include at least one system. Wherein, the at least one system is selected from a group including but being not limited to: GSM, WCDMA, TD-SCDMA and LTE. Wherein, the set of system information corresponding to the set of geographic information that is obtained by accessing to a bank of information, which may at least include a corresponding relationship between the set of geographic information and the set of system information. For example, MCC of People's Republic of China is 460, and the MCC 460 corresponds to a group of systems including: GSM, TD-SCDMA and LTE.

Specifically, the bank of information is obtained by pre-configuration such as installing software including the bank of information, factory setting by a device vendor, etc. Wherein, the bank of information is stored in a non-transitory storage medium. Wherein, the non-transitory storage medium may be selected from a group including but being not limited to: a Read-Only Memory (ROM), a Random Access Memory (RAM), a flash memory, an Erasable Programmable ROM (EPROM), an Electrically Erasable Programmable ROM (EEPROM), a circuit card, a magnetic card, an optical card and any type of disk including a floppy disk, an optical disk, a Compact Disc-ROM (CD-ROM) and a magnetic-optical disk.

In some embodiments, in S103, the apparatus obtains a set of system information corresponding to the set of geographic information, wherein the set of system information may include at least one system. Wherein, the at least one system is selected from a group including but being not limited to: GSM, WCDMA, TD-SCDMA and LTE. Wherein, the set of system information corresponding to the set of geographic information that is obtained by accessing to the bank of information, which may at least include a corresponding relationship between the set of geographic information and the set of system information. Wherein, the apparatus supports the at least one system.

Specifically, in S105, the apparatus obtains at least one band for the at least one system. Wherein, the at least one band is a set of continuous frequencies. For example, the 3rd Generation Partnership Project (3GPP) defines a band 40 is a set of continuous frequencies ranging from 2300 MHz to 2400 MHz.

In some embodiments, in S105, the apparatus obtains at least one band for the at least one system. Wherein, the at least one band is a set of continuous frequencies. Wherein, obtaining at least one band for the at least one system may include: obtaining all bands supported by the apparatus for each of the at least one system. For example, the GSM system and the WCDMA system are obtained from the set of system information corresponding to the set of geographic information and supported by a particular cell phone. Then, the particular cell phone obtains all supported bands for the GSM system and all supported bands for the WCDMA system, respectively.

In some embodiments, in S105, the apparatus obtains at least one band for the at least one system. Wherein, the at least one band is a set of continuous frequencies. Wherein, obtaining at least one band for the at least one system may include: obtaining at least one band corresponding to the set of geographic information for the at least one system. Wherein, the at least one band corresponding to the set of geographic information is obtained by accessing to a bank of information, where the bank of information may at least include a corresponding relationship between the set of geographic information and the set of system information. For example, MCC of the United States of America is 310, and, for the at least one system, the MCC 310 corresponds to a group of bands including: 5, 9 and 41.

Specifically, the bank of information is obtained by pre-configuration such as installing software including the bank of information, factory setting by a device vendor, etc. Wherein, the bank of information is stored in a non-transitory storage medium. Wherein, the non-transitory storage medium may be selected from a group including but being not limited to: a Read-Only Memory (ROM), a Random Access Memory (RAM), a flash memory, an Erasable Programmable ROM (EPROM), an Electrically Erasable Programmable ROM (EEPROM), a circuit card, a magnetic card, an optical card and any type of disk including a floppy disk, an optical disk, a Compact Disc-ROM (CD-ROM) and a magnetic-optical disk.

In some embodiments, in S105, the apparatus obtains at least one band for the at least one system. Wherein, the at least one band is a set of continuous frequencies. Wherein, obtaining at least one band for the at least one system may include: obtaining at least one band corresponding to the set of geographic information for the at least one system. Wherein, the apparatus supports the at least one band.

Wherein, the at least one band corresponding to the set of geographic information is obtained by accessing to the bank of information, where the bank of information may at least include a corresponding relationship between the set of geographic information and the set of system information.

In some embodiments, in S105, the apparatus obtains at least one band for the at least one system. Wherein, the at least one band is a set of continuous frequencies. Wherein, obtaining at least one band for the at least one system may include: obtaining at least one band corresponding to the set of geographic information for each of the at least one system.

Wherein, the at least one band corresponding to the set of geographic information is obtained by accessing to a bank of information, which may at least include a corresponding relationship among the set of geographic information, the set of system information and the at least one band. For example, the MCC of People's Republic of China is 460, and the MCC 460 corresponds to a group of bands including: 13, 19, 23, 27, 37 and 40. Wherein, the band 13 and the band 27 are for the GSM system, the band 23 and the band 40 are for the WCDMA system, and the band 19 and the band 37 are for the LTE system.

Specifically, the bank of information is obtained by pre-configuration such as installing software including the bank of information, factory setting by a device vendor, etc. Wherein, the bank of information is stored in a non-transitory storage medium. Wherein, the non-transitory storage medium may be selected from a group including but being not limited to: a Read-Only Memory (ROM), a Random Access Memory (RAM), a flash memory, an Erasable Programmable ROM (EPROM), an Electrically Erasable Programmable ROM (EEPROM), a circuit card, a magnetic card, an optical card and any type of disk including a floppy disk, an optical disk, a Compact Disc-ROM (CD-ROM) and a magnetic-optical disk.

In some embodiments, in S105, the apparatus obtains at least one band for the at least one system. Wherein, the at least one band is a set of continuous frequencies. Wherein, obtaining at least one band for the at least one system may include: obtaining at least one band corresponding to the set of geographic information for each of the at least one system. Wherein, the apparatus supports the at least one band.

Wherein, the at least one band corresponding to the set of geographic information is obtained by accessing to the bank of information, where the bank of information may at least include a corresponding relationship among the set of geographic information, the set of system information and the at least one band.

Specifically, in S107, the apparatus searches the at least one band for the at least one system. Wherein, a PLMN search may be employed for searching the at least one band for the at least one system.

In some embodiments, in S107, the apparatus searches the at least one band for the at least one system. Wherein, a PLMN search may be employed for searching the at least one band for the at least one system. Wherein, searching the at least one band for the at least one system may include: searching all bands supported by the apparatus for each of the at least one system.

In some embodiments, in S107, the apparatus searches the at least one band for the at least one system. Wherein, a PLMN search may be employed for searching the at least one band for the at least one system. Wherein, searching the at least one band for the at least one system may include: searching the at least one band corresponding to the set of geographic information for the at least one system, where the apparatus supports the at least one band.

In some embodiments, in S107, the apparatus searches the at least one band for the at least one system. Wherein, a PLMN search may be employed for searching the at least one band for the at least one system. Wherein, searching the at least one band for the at least one system may include: searching the at least one band corresponding to the set of geographic information for each of the at least one system, where the apparatus supports the at least one band.

Specifically, the apparatus may include at least one processor (e.g. CPU, microprocessor, etc), which is at least configured for performing the step that searching the at least one band for the at least one system.

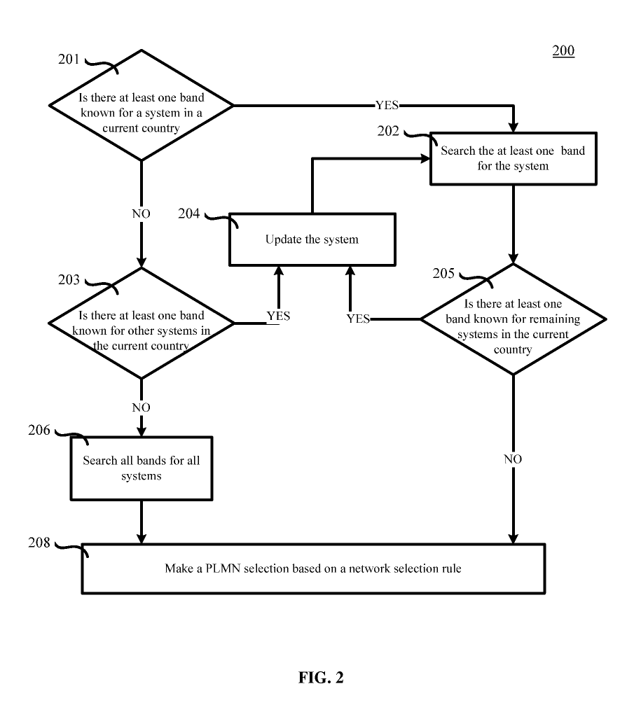

FIG. 2 schematically illustrates a block diagram presenting an implementation 200 of the method for searching a mobile network according to one embodiment in the present disclosure.

Referring to FIG. 2, the implementation 200 starts from a step 201 that an apparatus determines whether there is at least one band known for a system in a current country. Wherein, the apparatus may support the at least one band. Wherein, the apparatus may have obtained a set of geographic information of the current country. Wherein, the system may be obtained from a set of system information corresponding to the set of the geographic information. For the step 201, if yes, the implementation 200 proceeds to a step 202 that the apparatus searches the at least one band for the system. If no, the implementation 200 proceeds to a step 203 that the apparatus determines whether there is at least one band known for other systems in the current country. Wherein, the other systems may be obtained from the set of system information corresponding to the set of the geographic information. For the step 203, if yes, the implementation 200 proceeds to a step 204 that the apparatus updates the system by one of the other systems, and then, the implementation 200 proceeds to the step 202 that the apparatus searches the at least one band for the system. If no, the implementation 200 proceeds to a step 206 that the apparatus searches all bands for all systems, and then, the implementation 200 proceeds to a step 208 that the apparatus makes a PLMN selection based on a network selection rule, where the embodiments of the present disclosure do not impose any limitation to the network selection rule. From the step 202, the implementation 200 proceeds to a step 205 that the apparatus determines whether there is at least one band known for remaining systems in the current country. Wherein, the remaining systems may be obtained from the set of system information corresponding to the set of the geographic information. If yes, the implementation 200 proceeds to the step 204 that the apparatus updates the system by one of the remaining systems, and then proceeds back to the step 202. Thus, a loop is formed. The implementation 200 may jump out from the loop if there is no band available for the remaining systems in the current country, and then, the implementation 200 proceeds to the step 208 that the apparatus makes a PLMN selection based on a network selection rule.

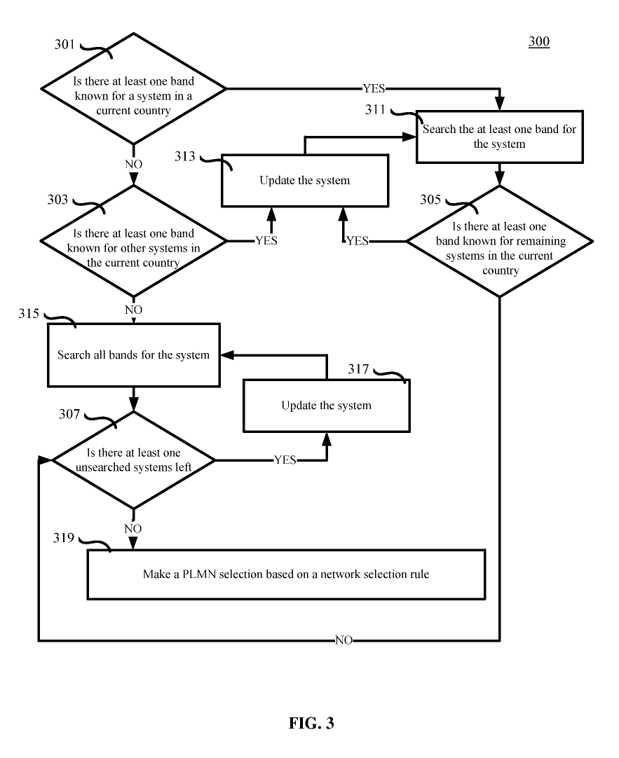

FIG. 3 schematically illustrates a block diagram presenting an implementation 300 of the method for searching a mobile network according to another embodiment in the present disclosure.

Referring to FIG. 3, the implementation 300 starts from a step 301 that an apparatus determines whether there is at least one band known for a system in a current country. Wherein, the apparatus may support the at least one band. Wherein, the apparatus may have obtained a set of geographic information of the current country. Wherein, the system may be obtained from a set of system information corresponding to the set of the geographic information. For the step 301, if yes, the implementation 300 proceeds to a step 311 that the apparatus searches the at least one band for the system. If no, the implementation 300 proceeds to a step 303 that the apparatus determines whether there is at least one band known for others system in the current country. Wherein, the other systems may be obtained from the set of system information corresponding to the set of the geographic information. For the step 303, if yes, the implementation 300 proceeds to a step 313 that the apparatus updates the system by one of the other systems, and then, the implementation 300 proceeds to the step 311 that the apparatus searches the at least one band for the system. If no, the implementation 300 proceeds to a step 315 that the apparatus searches all bands for the system, and then, the implementation 300 proceeds to a step 307 that the apparatus determines whether there is at least one unsearched system left. If yes, the implementation 300 proceeds to a step 317 that the apparatus updates the system by one of the at least one unsearched system, and then, the implementation 300 proceeds back to the step 315. Thus, a first loop is formed. The implementation 300 may jump out from the first loop, if there is no unsearched system left; then, the implementation 300 proceeds to a step 319 that the apparatus makes a PLMN selection based on a network selection rule, where the embodiments of the present disclosure do not impose any limitation to the network selection rule. From the step 311, the implementation 300 proceeds to a step 305 that the apparatus determines whether there is at least one band known for remaining systems in the current country. Wherein, the remaining systems may be obtained from the set of system information corresponding to the set of the geographic information. For the step 305, if yes, the implementation 300 proceeds to the step 313 that the apparatus updates the system by one of the remaining systems, and then proceeds back to the step 311. Thus, a second loop is formed. The implementation 300 may jump out from the second loop, if there is no band available for the remaining systems in the current country, and then, the implementation 300 proceeds to the step 307 and enter the first loop. The implementation 300 may jump out from the first loop, if there is no unsearched system left. After jumping out from the first loop, the implementation 300 proceeds to the step 319 that the apparatus makes a PLMN selection based on a network selection rule.

FIG. 4 schematically illustrates a diagram presenting an example 400 for the implementation 200 of the method for searching a mobile network according to one embodiment in the present disclosure.

Referring to FIG. 4, the example 400 is performed according to the implementation 200. An apparatus has obtained a bank of information. The bank of information includes first multiple bands supported by the apparatus for the LTE system (e.g. the first multiple bands include bands 1, 3, 7, 12, 20, 25, 38, 39, 40 and 41), and second multiple bands supported by the apparatus for the WCDMA system (e.g. the second multiple bands include bands 1, 2 and 3). The bank of information also includes a set of system information corresponding to a set of geographic information. Wherein, the set of geographic information includes multiple MCCs that 460, 244, 243 and 208. Wherein, the set of system information includes two systems that the LTE system and the WCDMA system. The bank of information further includes multiple bands corresponding to the set of geographic information for the two systems. The multiple bands include bands 1, 2, 3, 4, 7, 8, 12, 20, 39 and 41. The multiple bands, the two systems and the multiple MCCs are organized into a chart as shown in FIG. 4, and a corresponding relationship among the multiple bands, the two systems and the multiple MCCs is established and presented in the chart. Furthermore, a MCC for a current country is provided, where, in this case, the MCC is 460, which is the MCC of People's Republic of China. According to the implementation 200 as shown in FIG. 2, the apparatus may obtain the band 39 and the band 41 for the LTE system in the case that the MCC is 460, where the band 39 and the band 41 are supported by the apparatus. Then, the apparatus may search the band 39 and the band 41 for the LTE system. For the WCDMA system, the apparatus may obtain the band 2, the band 4 and the band 8 in the case that the MCC is 460, where only the band 2 is supported by the apparatus. Thereafter, the apparatus may search the band 2 for the WCDMA system.

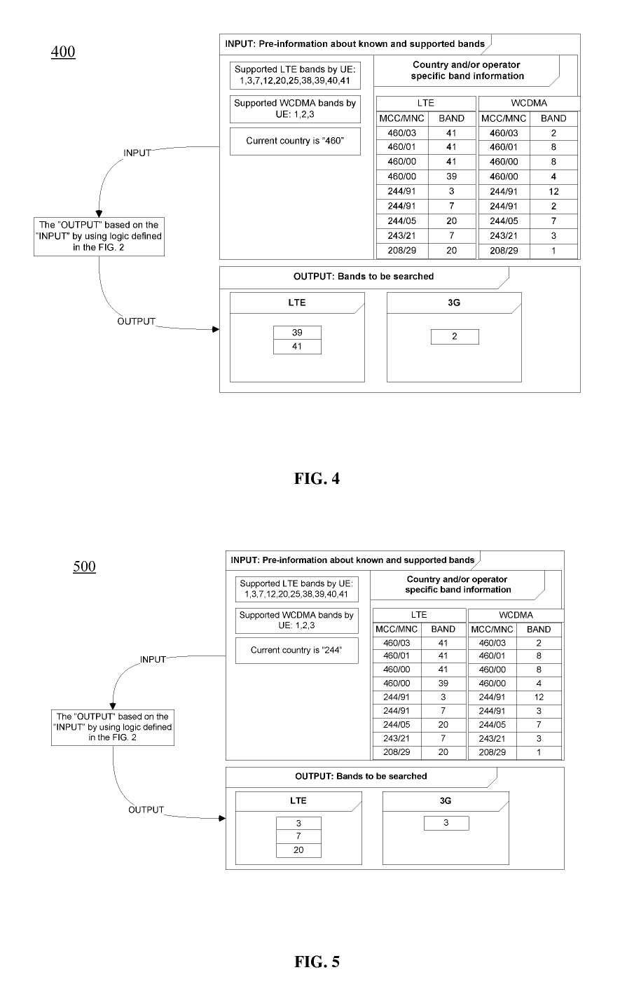

FIG. 5 schematically illustrates a diagram presenting another example 500 for the implementation 200 of the method for searching a mobile network according to one embodiment in the present disclosure.

Referring to FIG. 5, the example 500 is performed according to the implementation 200. An apparatus has obtained a bank of information. The bank of information includes first multiple bands supported by the apparatus for the LTE system (e.g. the first multiple bands include bands 1, 3, 7, 12, 20, 25, 38, 39, 40 and 41), and second multiple bands supported by the apparatus for the WCDMA system (e.g. the second multiple bands include bands 1, 2 and 3). The bank of information also includes a set of system information corresponding to a set of geographic information. Wherein, the set of geographic information includes multiple MCCs that 460, 244, 243 and 208. Wherein, the set of system information includes two systems that the LTE system and the WCDMA system. The bank of information further includes multiple bands corresponding to the set of geographic information for the two systems. The multiple bands include bands 1, 2, 3, 4, 7, 8, 12, 20, 39 and 41. The multiple bands, the two systems and the multiple MCCs are organized into a chart as shown in FIG. 5, and a corresponding relationship among the multiple bands, the two systems and the multiple MCCs is established and presented in the chart. Furthermore, a MCC for a current country is provided, where, in this case, the MCC is 244, which is the MCC of Finland. According to the implementation 200 as shown in FIG. 2, the apparatus may obtain the band 3, the band 7 and the band 20 for the LTE system in the case that the MCC is 244, where the band 3, the band 7 and the band 20 are supported by the apparatus. Then, the apparatus may search the band 3, the band 7 and the band 20 for the LTE system. For the WCDMA system, the apparatus may obtain the band 3, the band 7 and the band 12 in the case that the MCC is 244, where only the band 3 is supported by the apparatus. Thereafter, the apparatus may search the band 3 for the WCDMA system.

The embodiments of the present disclosure provide an apparatus for searching a mobile network, where the apparatus may include:
at least one processor configured for:
obtaining a set of geographic information indicating a location of the apparatus;
obtaining a set of system information corresponding to the set of geographic information, wherein the set of system information may include at least one system;
obtaining at least one band for the at least one system; and
searching the at least one band for the at least one system.

Specifically, the at least one processor is configured for obtaining a set of geographic information indicating a location of the apparatus. Wherein, the set of geographic information may include but be not limited to: a country code such as MCC, or a GPS coordinate.

Specifically, the at least one processor is configured for obtaining a set of system information corresponding to the set of geographic information, wherein the set of system information may include at least one system. Wherein, the at least one system is selected from a group including but being not limited to: GSM, WCDMA, TD-SCDMA and LTE.

In some embodiments, the at least one processor is configured for obtaining a set of system information corresponding to the set of geographic information, wherein the set of system information may include at least one system. Wherein, the at least one system is selected from a group including but being not limited to: GSM, WCDMA, TD-SCDMA and LTE. Wherein, the set of system information corresponding to the set of geographic information that is obtained by accessing to a bank of information, which may at least include a corresponding relationship between the set of geographic information and the set of system information.

Specifically, the bank of information is obtained by pre-configuration such as installing software including the bank of information, factory setting by a device vendor, etc. Wherein, the bank of information is stored in a non-transitory storage medium. Wherein, the non-transitory storage medium may be selected from a group including but being not limited to: a Read-Only Memory (ROM), a Random Access Memory (RAM), a flash memory, an Erasable Programmable ROM (EPROM), an Electrically Erasable Programmable ROM (EEPROM), a circuit card, a magnetic card, an optical card and any type of disk including a floppy disk, an optical disk, a Compact Disc-ROM (CD-ROM) and a magnetic-optical disk.

In some embodiments, the at least one processor is configured for obtaining a set of system information corresponding to the set of geographic information, wherein the set of system information may include at least one system. Wherein, the at least one system is selected from a group including but being not limited to: GSM, WCDMA, TD-SCDMA and LTE. Wherein, the set of system information corresponding to the set of geographic information that is obtained by accessing to the bank of information, which may include a corresponding relationship between the set of geographic information and the set of system information. Wherein, the apparatus supports the at least one system.

Specifically, the at least one processor is configured for obtaining at least one band for the at least one system. Wherein, the at least one band is a set of continuous frequencies.

In some embodiments, the at least one processor is configured for obtaining at least one band for the at least one system. Wherein, the at least one band is a set of continuous frequencies. Wherein, the at least one processor is configured for obtaining at least one band for the at least one system may include: the at least one processor is configured for obtaining all bands supported by the apparatus for each of the at least one system.

In some embodiments, the at least one processor is configured for obtaining at least one band for the at least one system. Wherein, the at least one band is a set of continuous frequencies. Wherein, the at least one processor is configured for obtaining at least one band for the at least one system may include: the at least one processor is configured for obtaining at least one band corresponding to the set of geographic information for the at least one system.

Wherein, the at least one processor is configured for obtaining the at least one band corresponding to the set of geographic information by accessing to a bank of information, where the bank of information may at least include a corresponding relationship between the set of geographic information and the set of system information.

Specifically, the bank of information is obtained by pre-configuration such as installing software including the bank of information, factory setting by a device vendor, etc. Wherein, the bank of information is stored in a non-transitory storage medium. Wherein, the non-transitory storage medium may be selected from a group including but being not limited to: a Read-Only Memory (ROM), a Random Access Memory (RAM), a flash memory, an Erasable Programmable ROM (EPROM), an Electrically Erasable Programmable ROM (EEPROM), a circuit card, a magnetic card, an optical card and any type of disk including a floppy disk, an optical disk, a Compact Disc-ROM (CD-ROM) and a magnetic-optical disk.

In some embodiments, the at least one processor is configured for obtaining at least one band for the at least one system. Wherein, the at least one band is a set of continuous frequencies. Wherein, the at least one processor is configured for obtaining at least one band for the at least one system may include: the at least one processor is configured for obtaining at least one band corresponding to the set of geographic information for the at least one system. Wherein, the apparatus supports the at least one band.

Wherein, the at least one processor is configured for obtaining the at least one band corresponding to the set of geographic information by accessing to the bank of information, where the bank of information may at least include a corresponding relationship between the set of geographic information and the set of system information.

In some embodiments, the at least one processor is configured for obtaining at least one band for the at least one system. Wherein, the at least one band is a set of continuous frequencies. Wherein, the at least one processor is configured for obtaining at least one band for the at least one system may include: the at least one processor is configured for obtaining at least one band corresponding to the set of geographic information for each of the at least one system.

Wherein, the at least one processor is configured for obtaining the at least one band corresponding to the set of geographic information by accessing to a bank of information, where the bank of information may at least include a corresponding relationship among the set of geographic information, the set of system information and the at least on band.

Specifically, the bank of information is obtained by pre-configuration such as installing software including the bank of information, factory setting by a device vendor, etc. Wherein, the bank of information is stored in a non-transitory storage medium. Wherein, the non-transitory storage medium may be selected from a group including but being not limited to: a Read-Only Memory (ROM), a Random Access Memory (RAM), a flash memory, an Erasable Programmable ROM (EPROM), an Electrically Erasable Programmable ROM (EEPROM), a circuit card, a magnetic card, an optical card and any type of disk including a floppy disk, an optical disk, a Compact Disc-ROM (CD-ROM) and a magnetic-optical disk.

In some embodiments, the at least one processor is configured for obtaining at least one band for the at least one system. Wherein, the at least one band is a set of continuous frequencies. Wherein, the at least one processor is configured for obtaining at least one band for the at least one system may include: the at least one processor is configured for obtaining at least one band corresponding to the set of geographic information for each of the at least one system. Wherein, the apparatus supports the at least one band.

Wherein, the at least one processor is configured for obtaining the at least one band corresponding to the set of geographic information by accessing to the bank of information, where the bank of information may at least include a corresponding relationship among the set of geographic information, the set of system information and the at least on band.

Specifically, the at least one processor is configured for searching the at least one band for the at least one system. Wherein, a PLMN search may be employed for searching the at least one band for the at least one system.

In some embodiments, the at least one processor is configured for searching the at least one band for the at least one system. Wherein, a PLMN search may be employed for searching the at least one band for the at least one system. Wherein, the at least one processor is configured for searching the at least one band for the at least one system may include: the at least one processor is configured for searching all bands supported by the apparatus for each of the at least one system.

In some embodiments, the at least one processor is configured for searching the at least one band for the at least one system. Wherein, a PLMN search may be employed for searching the at least one band for the at least one system. Wherein, the at least one processor is configured for searching the at least one band for the at least one system may include: the at least one processor is configured for searching the at least one band corresponding to the set of geographic information for the at least one system, where the apparatus supports the at least one band.

In some embodiments, the at least one processor is configured for searching the at least one band for the at least one system. Wherein, a PLMN search may be employed for searching the at least one band for the at least one system. Wherein, the at least one processor is configured for searching the at least one band for the at least one system may include: the at least one processor is configured for searching the at least one band corresponding to the set of geographic information for each of the at least one system, where the apparatus supports the at least one band.

Although the present disclosure has been disclosed above with reference to preferred embodiments thereof, it should be understood by those skilled in the art that various changes may be made without departing from the spirit or scope of the disclosure. Accordingly, the present disclosure is not limited to the embodiments disclosed.

What is claimed is:

1. A method for searching a mobile network, comprising:
an apparatus, obtaining a set of geographic information indicating a location of the apparatus;
obtaining a set of system information corresponding to the set of geographic information, wherein the set of system information comprises at least one system;
obtaining at least one band for the at least one system; and
searching the at least one band for the at least one system.

2. The method according to claim 1, wherein the set of geographic information comprises: a country code or a Global Positioning System coordinate.

3. The method according to claim 1, wherein the at least one system is selected from a group of 3rd Generation Partnership Project Radio Access Technologies.

4. The method according to claim 3, wherein the group of 3rd Generation Partnership Project Radio Access Technologies comprises: Global System for Mobile communications, Wideband Code Division Multiple Access, Time Division-Synchronous Code Division Multiple Access and Long Term Evolution.

5. The method according to claim 1, wherein the set of system information corresponding to the set of geographic information is obtained by accessing to a bank of information, where the bank of information at least comprises a corresponding relationship between the set of geographic information and the set of system information.

6. The method according to claim 1, further comprising: determining whether the at least one system is supported by the apparatus prior to obtaining at least one band for the at least one system.

7. The method according to claim 1, wherein obtaining at least one band for the at least one system comprises: obtaining all bands supported by the apparatus for each of the at least one system.

8. The method according to claim 1, wherein obtaining at least one band for the at least one system comprises: obtaining at least one band corresponding to the set of geographic information for the at least one system.

9. The method according to claim 1, wherein obtaining at least one band for the at least one system comprises: obtaining at least one band corresponding to the set of geographic information for each of the at least one system.

10. The method according to claim 1, further comprising: determining whether the at least one band is supported by the apparatus prior to searching the at least one bands for the at least one system.

11. An apparatus for searching a mobile network, comprising:
at least one processor configured for:
obtaining a set of geographic information indicating a location of the apparatus;
obtaining a set of system information corresponding to the set of geographic information, wherein the set of system information comprises at least one system;
obtaining at least one band for the at least one system; and
searching the at least one band for the at least one system.

12. The apparatus according to claim 11, wherein the set of geographic information comprises: a country code or a Global Positioning System coordinate.

13. The apparatus according to claim 11, wherein the at least one system is selected from a group of 3rd Generation Partnership Project Radio Access Technologies.

14. The apparatus according to claim 13, wherein the group of 3rd Generation Partnership Project Radio Access Technologies comprises: Global System for Mobile communications, Wideband Code Division Multiple Access, Time Division-Synchronous Code Division Multiple Access and Long Term Evolution.

15. The apparatus according to claim 11, wherein the at least one processor is configured for obtaining the set of system information corresponding to the set of geographic information by accessing to a bank of information, where the bank of information at least comprises a corresponding relationship between the set of geographic information and the set of system information.

16. The apparatus according to claim 11, wherein the at least one processor is further configured for determining whether the at least one system is supported by the apparatus prior to the at least one processor is configured for obtaining at least one band for the at least one system.

17. The apparatus according to claim 11, wherein the at least one processor is configured for obtaining at least one band for the at least one system comprises: the at least one processor is configured for obtaining all bands supported by the apparatus for each of the at least one system.

18. The apparatus according to claim 11, wherein the at least one processor is configured for obtaining at least one band for the at least one system comprises: the at least one processor is configured for obtaining at least one band corresponding to the set of geographic information for the at least one system.

19. The apparatus according to claim 11, wherein the at least one processor is configured for obtaining at least one band for the at least one system comprises: the at least one processor is configured for obtaining at least one band corresponding to the set of geographic information for each of the at least one system.

20. The apparatus according to claim 11, wherein the at least one processor is further configured for determining whether the at least one band is supported by the apparatus prior to the at least one processor is configured for searching the at least one bands for the at least one system.
